(19) United States
(12) Patent Application Publication
(10) Pub. No.: US 2009/0167547 A1
(43) Pub. Date: Jul. 2, 2009

(54) Utility disconnect monitor node with communication interface

(76) Inventor: Brad Gilbert, Burlingame, CA (US)

Correspondence Address: BUCHANAN, INGERSOLL & ROONEY PC, POST OFFICE BOX 1404, ALEXANDRIA, VA, 22313-1404, US

(21) Appl. No.: 12/003,711

(22) Filed: Dec. 31, 2007

(51) Int. Cl. G08B 21/00

(52) U.S. Cl. 340/662

(57) ABSTRACT

An apparatus for monitoring the presence of voltage on the load side of a utility meter socket includes a circuit for detecting the presence of voltage on the load side output of the socket and a communication device connected to the circuit to transmit data relating to the presence of voltage on the load side output to the utility. Also provided is a method of monitoring the voltage on the load side of the utility, the method including installing an electric utility Disconnect Monitor Node into a utility meter socket, detecting the presence of voltage on the load side output of the utility meter socket, and transmitting data relating to the presence of voltage on the load side output.

### FIELD OF THE INVENTION

The present invention relates to utility networks and devices, and more particularly to devices and methods for detecting, monitoring, and controlling the utilization of electric power on the load side of a utility meter socket, and communicating with a utility server over a wireless network.

### SUMMARY

In one embodiment, the invention provides an electric utility Disconnect Monitor Node, adapted to be plugged into a utility meter socket having an electrical service input, a load side output and a socket for receiving either a meter or a Disconnect Monitor Node. The Disconnect Monitor Node comprises a circuit for detecting the presence of voltage on the load side output of the socket and a communication device connected to the circuit to transmit data relating to the presence of voltage on the load side output to the utility.

In another embodiment, the invention provides an electric utility Disconnect Monitor Node, adapted to be plugged into a utility meter socket having an electrical service input, a load side output and a socket for receiving either a meter or a Disconnect Monitor Node. The Disconnect Monitor Node comprises a circuit for detecting the presence of voltage on the load side output of the socket. In one embodiment, the circuit includes a circuit element to detect voltage, and an analog-to-digital connector connected to the circuit element to convert the voltage to a digital value of voltage. The Disconnect Monitor Node also comprises a wireless network interface device connected to the circuit to receive the digital value of voltage, and transmit data relating to the presence of voltage on the load side output to the utility. In one form, the wireless interface device is configured to receive and retransmit communications from nearby utility network devices.

In yet another embodiment, a method comprises installing an electric utility Disconnect Monitor Node into a utility meter socket having an electrical service input, a load side output and a socket for receiving either a meter or a Disconnect Monitor Node, the Disconnect Monitor Node comprising a circuit for detecting the presence of voltage on the load side output of the socket, and a communication device connected to the circuit to transmit data relating to the presence of voltage on the load side output to the utility; detecting the presence of voltage on the load side output of the utility meter socket; and transmitting data relating to the presence of voltage on the load side output.

### BRIEF DESCRIPTION OF THE DRAWINGS

FIG. 1A shows an embodiment of a utility meter socket and a Disconnect Monitor Node mounted thereon.

FIG. 1B shows an exploded view of the utility meter socket and the Disconnect Monitor Node, showing the mechanical integration feature.

FIG. 2 is a schematic representation of the Disconnect Monitor Node communicating through various networks with local devices and the utility.

FIG. 3A is a schematic representation of the major components of the Disconnect Monitor Node in one embodiment of the invention.

FIG. 3B is a schematic illustration of the circuitry of the Disconnect Monitor Node.

FIG. 3C is a schematic representation of the Disconnect Monitor Node with a Disconnect Alert device in another embodiment of the invention.

FIG. 3D is a schematic representation of the Disconnect Monitor Node with a CAP-powered or battery-powered Last-Gasp Device in another embodiment of the invention.

FIG. 3E is a schematic representation of the Disconnect Monitor Node with a Display Indicator in another embodiment of the invention.

FIG. 3F is a schematic representation of the Disconnect Monitor Node with an FSU (Field Service Unit) Interface in another embodiment of the invention.

FIG. 3G is a schematic representation of the Disconnect Monitor Node with a Connection Switch/Monitor Interface in one embodiment of the invention wherein an external user device can temporarily be connected to the power source.

FIG. 3H is a schematic representation of the Disconnect Monitor Node with an Interface to water and gas meters to provide them with network connectivity.

### DETAILED DESCRIPTION

Exemplary embodiments of the invention are explained in detail hereinafter. It will be appreciated that the invention is not limited in its application to the details of construction and the arrangement of components set forth in the following description or illustrated in the accompanying drawings. The invention is capable of other embodiments and of being practiced or of being carried out in various ways. Also, the phraseology and terminology used herein is for the purpose of description and should not be regarded as limiting. The use of “including,” “comprising,” or “having” and variations thereof herein is meant to encompass the items listed thereafter and equivalents thereof as well as additional items.

As should be apparent to one of ordinary skill in the art, the systems, networks and devices shown in the figures are models of what actual systems, networks or devices might be like. As noted, many of the modules and logic structures described are capable of being implemented in software executed by a microprocessor or a similar device or of being implemented in hardware using a variety of components including, for example, application specific integrated circuits (“ASICs”). Terms like “processor” can include or refer to both hardware and/or software. Furthermore, throughout the specification capitalized terms are used. Such terms are used to conform to common practices and to help correlate the description with the drawings. However, no specific meaning is implied or should be inferred simply due to the use of capitalization. Thus, the invention is not limited to the specific examples or terminology or to any specific hardware or software implementation or combination of software or hardware.

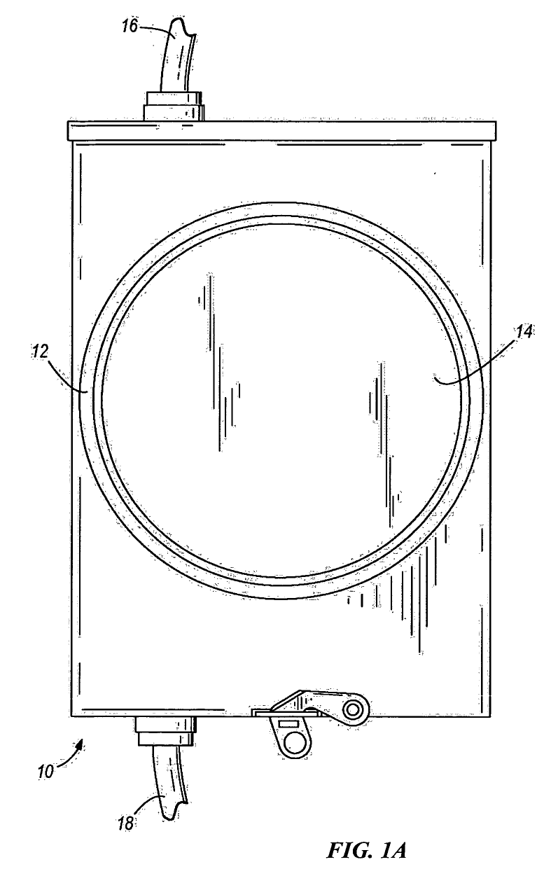

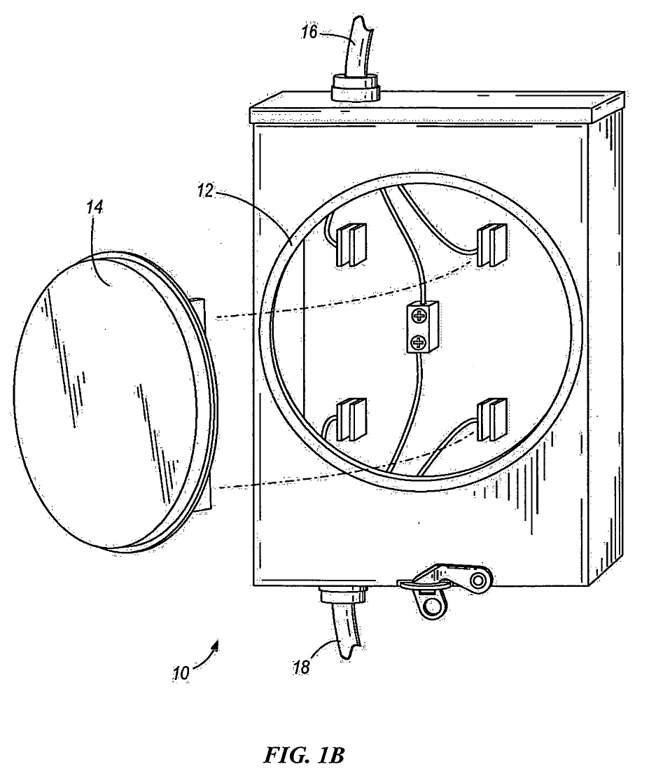

FIGS. 1A and 1B illustrate an electric utility meter assembly 10 including an electric utility meter socket 12 and an electric utility power Disconnect Monitor Node 14, formed to appear as a meter blank, embodying the invention. The meter socket 12 is adapted to receive and be coupled with either a meter (not shown) or a Disconnect Monitor Node 14. When service is disconnected from a premises, the meter is removed, and the Disconnect Monitor Node 14 can be connected to the meter socket 12 to protect against electrical hazards and to detect the presence of a voltage. The Disconnect Monitor 14 in the electric utility meter assembly 10 illustrated in FIGS. 1A and 1B includes terminals for connection to an electrical service input 16 and a load side output 18. The meter assembly 10 receives electrical energy and other data from the service input 16 and transmits the electrical energy and additional data through the load side output 18 to the electrical power distribution circuit of the premises with which the meter assembly is associated.

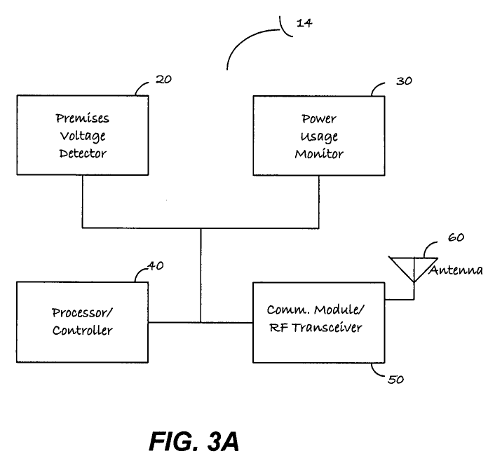

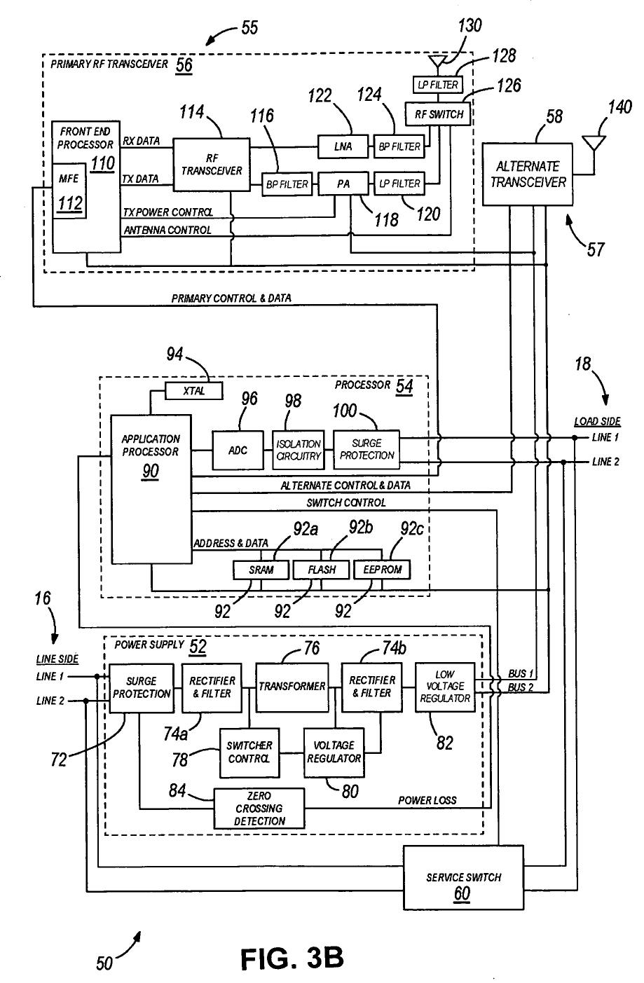

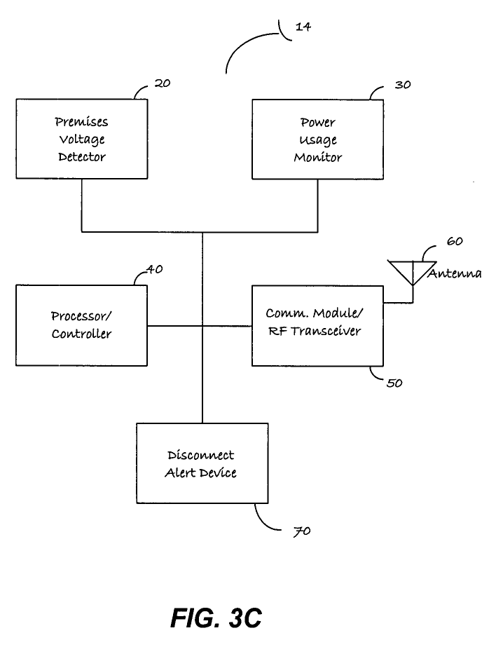

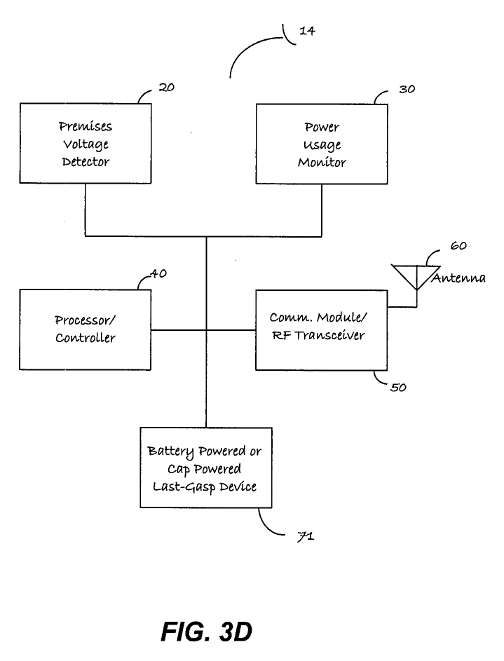

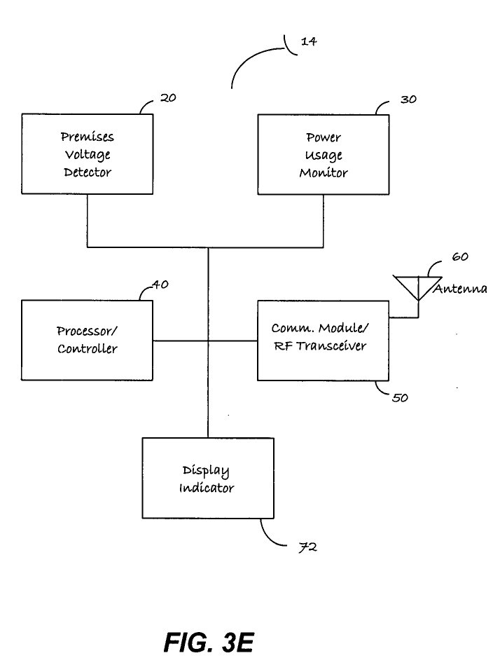

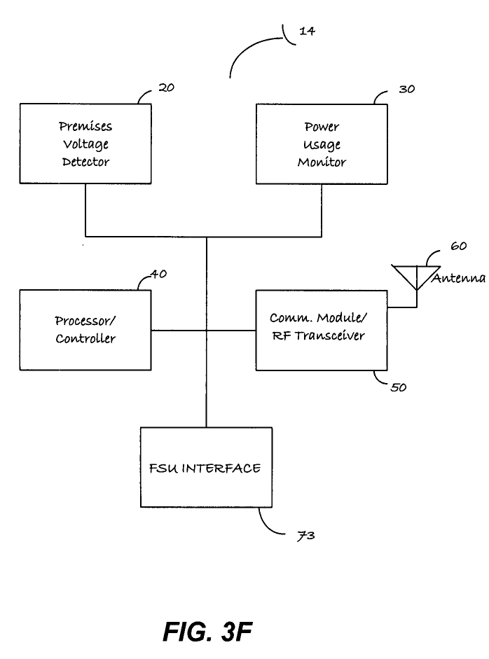

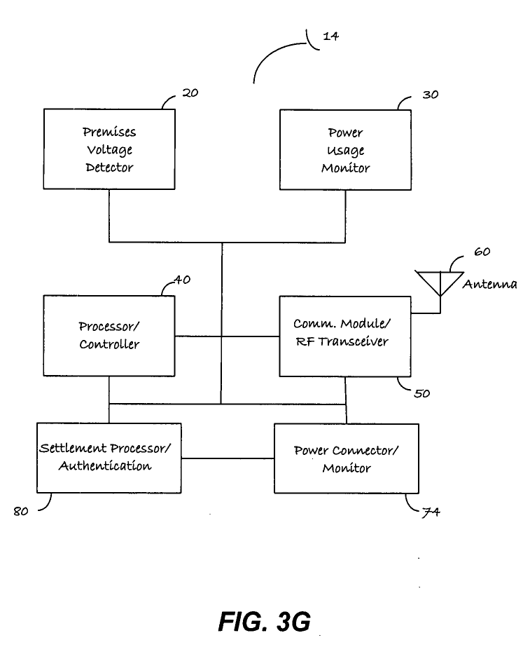

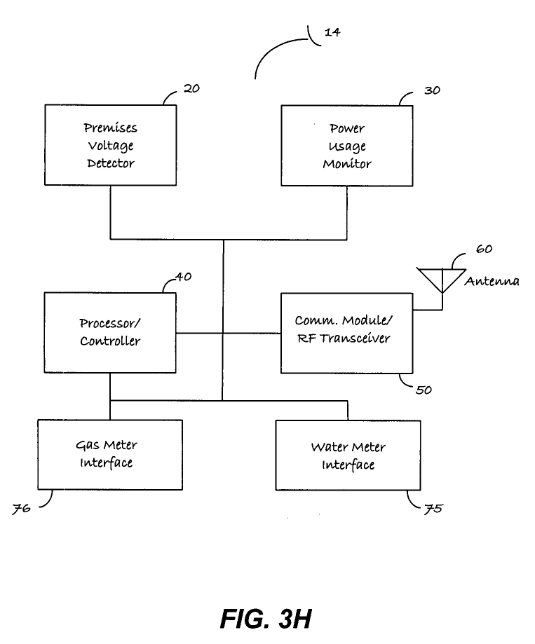

During operation, an operator can install the electric utility Disconnect Monitor Node 14 into the electric utility meter socket 12 in the electric utility meter assembly 10. A meter reading device (not shown) or a different Disconnect Monitor Node can previously have been installed in the utility meter socket 12, so the operator must typically remove the installed device before installing the Disconnect Monitor Node 14. The electric utility Disconnect Monitor Node 14 is installed into the meter socket 12 such that its voltage detecting circuit (shown in FIG. 3B) monitors voltage on the load side output 18.

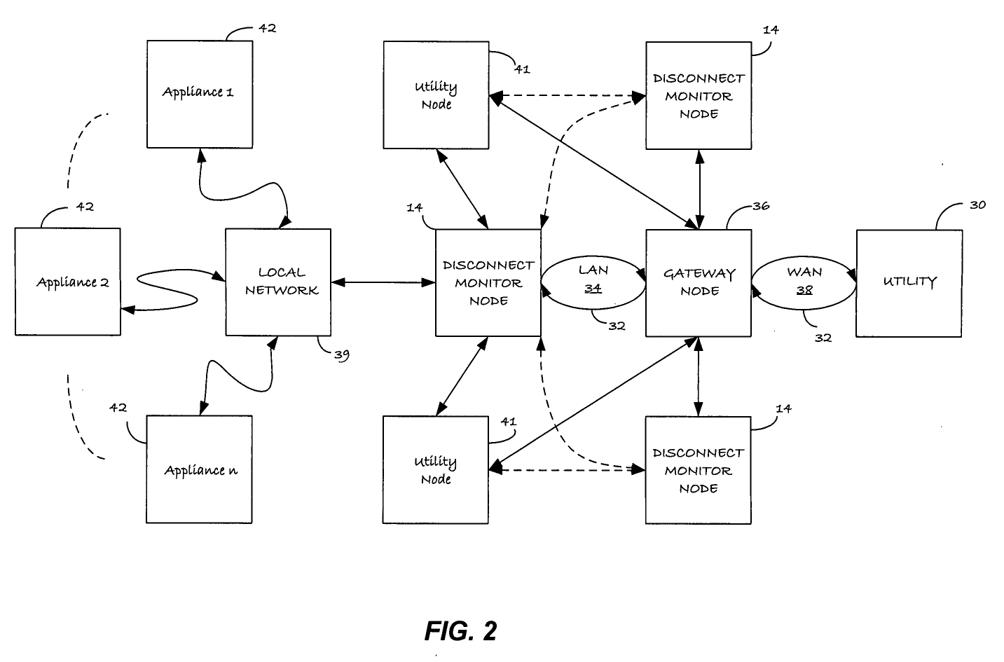

FIG. 2 provides a schematic description of how the Disconnect Monitor Node 14 performs different functions in a network environment. FIG. 2 illustrates how the Disconnect Monitor Node 14 is in communication with a utility company 30 through one or more communication networks 32 via a Gateway node 36. The Disconnect Monitor Node 14 can be connected to a first network 34 to both transmit and receive data, such as a local area network (LAN), as shown in the illustrated embodiment. Utility nodes 41 m also be connected to the first network 34, either directly or via the Disconnect Monitor Node 14. Utility nodes 41 can be coupled to electric utility meters, or can include electric utility meters. The Disconnect Monitor Node 14 may be able to communicate directly with utility nodes 41, or other Disconnect Monitor Nodes 14 in the first network 34. The Disconnect Monitor Node 14 can communicate with the gateway node 36 directly or through one or more utility nodes 41, or through one or more Disconnect Monitor Nodes 14. In some embodiments, the LAN can be based on, but not limited to, one of frequency-hopping spread spectrum, direct-sequence spread spectrum, time division multiple access, orthogonal frequency-division multiplexing, or other. The LAN 34 can utilize data protocols including, but not limited to, IPv4, IPv6, ZigBee, or a proprietary protocol. In other embodiments, the first network 34 can be another type of communication network 32, such as, for example, a campus area network (CAN), a metropolitan area network (MAN), or the like. The LAN or first network 34 can be connected to a gateway node 36 to generally link and control access to a second network 38. In the illustrated embodiment, the second network 38 is a wide area network (WAN). However, in other embodiments, the second network 38 can be another type of communication network 32. As illustrated, the first network 34 can both transmit and receive data to and from the second network 38 through the gateway node 36. In the illustrated embodiment, the second network 38 is connected to the utility company 30 to both transmit and receive data. Therefore, the Disconnect Monitor Node 14 generally transmits and receives data to and from the utility company 30 through the first network 34 and second network 38. In further embodiments, the Disconnect Monitor Node 14 can transmit and receive data to and from the utility company 30 directly, through one communication network 32, or through three or more communication networks 32.

As illustrated in FIG. 2, the Disconnect Monitor Node 14 can also be connected to a local network 39 on a premises, also referred to as an in-premises (in-prem) network or home area network (HAN), to both transmit and receive data to and from the in-prem network 39. The in-prem network 39 can be based on any one of data communication protocols Ipv4, IPv6, Zigbee, or 6LowPAN. The in-prem network 39 can include one or more in-prem devices 42, such as appliances, as illustrated. Exemplary in-prem devices can include, without limitation, refrigerator, heater, light(s), cooking appliances, A/C, swimming pool controls, surveillance cameras, etc. The devices 42 in the in-prem network 39 are therefore connected to the utility company 30 through the communication networks 32 and the Disconnect Monitor Node 14, and are capable of receiving both data and electrical energy from the utility company 30 and transmitting data back to the utility company 30.

One embodiment of the Disconnect Monitor Node is illustrated in FIG. 3A. The Disconnect Monitor Node 14, which plugs into the meter socket panel as indicated in FIGS. 1A & 1B, can have four components in the illustrated embodiment. A Voltage Detector 20 senses and reports to a Processor/Controller 40 any detection of voltage on the load side. A Power Usage Monitor 30 allows for connecting to the utility line to receive power, monitoring and reporting such usage, via the Processor/Controller 40. The Processor/Controller 40 manages all data monitor, storage, reporting and scheduling functions and also sets up messages for sending to the utility network or receiving and processing of messages from the utility network. A Communications Module/RF Transceiver 50 maintains two-way packet communications link with the gateway via the LAN or the WAN to which it is connected, via an antenna 60. Each of these components is securely mounted in a base that conforms to a utility meter blank and plugs into the meter socket 12.

### DETAILED DESCRIPTION OF AN EXEMPLARY EMBODIMENT

A voltage detecting circuit of the Disconnect Monitor Node illustrated in FIG. 3A is shown in detail in FIG. 3B. As described in connection with FIGS. 3A-3F, the Disconnect Monitor Node can act as a monitoring and reporting device for detecting the presence of voltage, for allowing and reporting power connection and usage, and for acting as a gateway to other networks connected to it. The voltage detecting circuit includes circuitry to monitor and detect the presence of a voltage on the load side output 18 or “premises side” output of the Disconnect Monitor Node 14, and a device that can communicate data relating to the presence of a voltage on the load side output 18, or “premises side” output of the Disconnect Monitor Node 14. A premises can be a house, apartment, office, building, etc. In some embodiments, as illustrated in FIG. 3B, the voltage detecting circuit can include a power supply 52 and a processor unit 54 for detecting the presence of a voltage on the load side output 18. In other embodiments, different circuitry and different circuit elements can be used to detect the presence of a voltage or to monitor and report temporary or permanent usage of power.

As illustrated in FIG. 3B, the voltage detecting circuit also includes a communication device 55 to transmit data relating to the presence of a voltage. In some embodiments, the communication device 55 can be an RF (radio frequency) transceiver 56, as illustrated in FIG. 3B. The Disconnect Monitor Node can include one or more RF transceivers. For example, in one embodiment, a second transceiver can be used to connect to other commodity meters (for example: water and gas meters). In yet another embodiment, the Disconnect Monitor Node can include a transceiver for the home area network communications. In some embodiments, the Disconnect Monitor can act as a gateway for some local networks such as the home area network as described below. In embodiments with two or more transceivers, one transceiver can be designated as the “primary” transceiver for communicating with the utility network.

In alternate embodiments, the communication device 55 can be any type of communication device, such as, for example, a network interface device, a different type of transceiver, a receiver, a transmitter, or the like, any of which can be wireless or communicate through a direct hard-wire connection. Moreover, the communication device 55 can employ any RF communication protocols including, but not limited to, frequency-hopping spread spectrum communication protocols, broadband communication protocols, direct-sequence spread spectrum modulation, and/or orthogonal frequency-division multiplexing modulation. Similarly, the communication device 55 can employ one or more data protocols including, but not limited to Ipv4, IPv6, X.25, proprietary packet protocols, or others.

In some embodiments, the voltage detecting circuit can also include one or more additional or alternate communication devices 57. As shown in FIG. 3B, in one form, the alternate communication device 57 is an alternate transceiver 58. In further embodiments, the alternate communication device 57 can be any type of communication device, such as, for example, a network interface device, a different type of transceiver, a receiver, a transmitter, or the like, any of which can be wireless or communicate through a direct hard-wire connection. Moreover, the communication device 57 can employ any RF communication protocols, including, but not limited to, frequency-hopping spread spectrum communication protocols, broadband communication protocols, direct-sequence spread spectrum modulation, and/or orthogonal frequency-division multiplexing modulation. Similarly, the communication device 57 can employ any type of data communication protocols including, but not limited to IPv4, IPv6, X.25, and proprietary packet protocols.

The communication device 55 and/or alternate communication device 57 can be configured to receive and/or transmit communications from nearby communication networks, such as, for example, a LAN 34 (see FIG. 2). In some embodiments, the communication device 55 and/or alternate communication device 57 can be configured to receive, transmit, and/or retransmit communications from devices 42 on a local network 39. In other embodiments, the communication device 55 and/or alternate communication device 57 can be configured to communicate using a frequency hopping, spread-spectrum communication protocol, broadband communication protocol, orthogonal frequency-division multiplexing, time-division multiple access, or any combination thereof.

In some embodiments, the voltage detecting circuit also includes a service switch 59 located between the service side input 16 and load side output 18 to selectively connect and disconnect the service input 16 to (and from) the load side output 18. Each of the above mentioned elements is generally connected to each other and located between the service side input 16 and load side output 18.

In some embodiments, service switch 59 in FIG. 3B can be used in conjunction with a settlement system, described below in connection with FIG. 3G, whereby temporary authorization of power can be provided to a user, thereby allowing connection of service side input to the premises side output to allow temporary power to the premises. As stated here, the “premises” can be a device, vehicle, appliance, or other, requiring temporary connection and power, and can provide the required authentication information to the utility network that is communicated via the Disconnect Monitor Node.

In some embodiments, as illustrated in FIG. 3B, the service side input 16 is connected to the voltage detecting circuit by its connection to the power supply 52. The power supply 52 allows for operation of the voltage detecting circuit over a voltage range, typically between 96 VAC and 277 VAC, to address a range of service input voltages. In some embodiments, the power supply 52 can also provide temporary energy storage to enable orderly shutdown of a device in the event of loss of service side input power 16. The power supply 52 can include a surge protecting element 72 to protect the voltage detecting circuit against voltage spikes. As illustrated in FIG. 3B, the surge protecting element 72 can be connected to a rectifier and filter element 74a, a transformer 76, and another rectifier and filter element 74b to convert between AC and DC voltage and to step up or step down the voltage. As illustrated, a switcher control element 78 is connected to the circuit between the first rectifier and filter element 74a and the transformer 76. The switcher control element 78 is also connected to a voltage regulator 80. The switcher control element 78 and voltage regulator 80 control the voltage by maintaining a generally constant voltage level. The voltage regulator 80 is connected to the connection between the transformer 76 and the second rectifier and filter element 74b, and also to the second rectifier and filter element 74b. The second rectifier and filter 74b is also connected to a low voltage regulator 82. A connection from the low voltage regulator 80 provides a line out of the power supply 52 to the processor unit 54, the primary RF transceiver 56, and the alternate transceiver 58. Additionally, the power supply 52 includes a zero crossing detection element 84 that detects the loss and restoration of power from the service input 16. The zero crossing detection element 84 is also connected to the processor unit 54.

As illustrated in FIG. 3B, the processor unit 54 can be a standard processor unit designed with additional circuitry for monitoring and detecting the presence of a voltage on the load side output 18 of the Disconnect Monitor Node 14. The processor unit 54 of the illustrated embodiment includes an application processor 90 which can interpret and execute computer programs and process data. The application processor 90 is connected to many of the other elements in the voltage detecting circuit to monitor and control the functioning of those elements. For example, the application processor 90 is connected to the service switch 59 via a switch control through which the application processor 90 and the service switch 59 exchange data.

In some embodiments, as illustrated, the processor unit 54 also includes a set of memory storage elements 92 that can include both volatile memory 92a, which retains stored data only if power is continuously supplied, and non-volatile memory 92b and 92c, which can preserve stored data even if power is not continuously supplied. In the illustrated embodiment, the volatile memory storage element 92a is a static random access memory (SRAM) storage element, and the non-volatile memory storage elements are a flash memory 92b and an electrically erasable programmable read-only memory (EEPROM) 92c. The program instructions for the application processor 90 can be stored in the non-volatile memory. In other embodiments, the memory elements 92 can be other types of volatile and non-volatile memory. The memory elements 92 are connected in parallel with both each other and with the application processor 90. Additionally, the memory storage elements 92 can be connected to the connection between the power supply 52 and the alternate transceiver 58, as illustrated.

In some embodiments, the processor unit 54 also includes a crystal oscillator (XTAL) 94 that is connected to the application processor 90. The crystal oscillator 94 can be used to create an electrical signal with a stabilized frequency for accurate use with the RF transceiver 56. In some embodiments, as illustrated in FIG. 3B, the processor 56 can include an analog to digital converter (ADC) 96, isolation circuitry 98, and surge protection circuitry 100. In the illustrated embodiment, the application processor 90 is connected in series to the ADC 96. The ADC 96 is an electronically integrated circuit that converts continuous electrical signals to digital signals. The ADC 96 can detect a voltage on the load side output 18 of the Disconnect Monitor Node 14 or meter socket 12 and convert the voltage to the digital value of voltage. The ADC 96 is also connected to the isolation circuitry 98, which guards against phase reversal on the load side output 18 and steps down the service side input 16 voltage to a useable level. The isolation circuitry 98 is connected to the surge protection circuitry 100 to guard against voltage surges on the load side output 18. In addition to the connections mentioned above, the processor unit 54 is also connected to the primary RF transceiver 56, the alternate transceiver 58, and the load side output 18.

As illustrated in FIG. 3B, the application processor 90 included in the processor unit 54 communicates primary control commands and data to a front end processor 110 included in the primary RF transceiver 56. As illustrated, the front end processor 110 can include a media access control front end processor (MAC front end processor, or MFE) 112. The MFE 112 determines where to direct different data signals to ensure that each signal is transmitted to the correct location and to prevent multiple signals from colliding. The front end processor 110 interfaces between a number of communication devices and signals included in the primary RF transceiver 56.

In one exemplary embodiment, another RF transceiver 114 is located in the primary RF transceiver 56, and can both transmit and receive data from the front end processor 110. Both the RF transceiver 114 and the front end processor 110 are connected to the low voltage regulator 82 in the power supply 52 and the application processor 90 and memory storage elements 92 in the processor unit 54. The RF transceiver 114 is connected in one series to a band pass (BP) filter 116, a power amplifier (PA) 118, and a low pass (LP) filter 120. In another series it is connected to a low noise amplifier (LNA) 122 and a band pass (BP) filter 124.

The front end processor 110 communicates through a number of pathways to an assembly which includes an RF switch 126, a low pass (LP) filter 128, and an RF transceiver antenna 130. One pathway from the front end processor 110, labeled “Antenna Control”, is direct, and responsible for communicating antenna control data to the assembly. On another pathway, transmission power control is communicated to and from the front end processor 110 through the PA 118 and LP filter 120 to the assembly comprising the RF switch 126, the LP filter 128, and the antenna 130. On yet another pathway, data is communicated from the RF transceiver 114 through the BP filter 116, the PA 118, and the LP filter 120 to the assembly. On still another pathway, data is communicated from the RF transceiver 114 through the LNA 122 and the BP filter 124 to the RF switch 126, the LP filter 128, and the antenna 130. These pathways enable communication of data at different frequencies through a series of different filters to screen out given frequencies and allow a clearer transmission signal. In some embodiments, the primary RF transceiver 56 can act as the communicating device 55 for receiving, transmitting, and/or retransmitting data between one or more alternate networks 32, local networks 39, devices 42, or the like, or any combination thereof.

As illustrated in FIG. 3B, the front end processor 110 and the power amplifier 118 in the primary RF transceiver 56, the application processor 90 in the processor unit 54, and the low voltage regulator 82 in the power supply 52 are each connected to the alternate transceiver 58. In some embodiments, the alternate transceiver 58 can have its own front-end processor and power amplifier. In some embodiments, the alternate transceiver 58 includes an antenna 140 and can act as the communicating device 55 for receiving, transmitting, and/or retransmitting data between one or more alternate networks 32, local networks 39, devices 42, or the like, or any combination thereof.

While the Disconnect Monitor Node 14 is installed in the meter socket 12, it monitors the load side output 18 to detect a voltage on the electrical power distribution circuit of the associated premises. In some embodiments, as depicted in FIG. 3B, the processor unit 54 and/or the power supply 52 monitors the load side output 18 to detect the presence of a voltage above a certain threshold. To monitor the voltage, the processor unit 54 takes a measurement of the value of the voltage and logs the measurement results with a timestamp. For instance, the ADC 96 takes the measurement by converting the voltage to the digital value of the voltage, the information is processed by the application processor 90, and stored in the volatile and/or non-volatile memory 92. If the processor unit 54 detects an increase in the voltage on the load side output 18 that crosses a predetermined threshold voltage stored in the memory, the processor unit 54 sends an “alert” signal to the communication device 55, which in some embodiments, can be the wireless network interface device. For instance, if the electrical service to the premises has been terminated, the sudden appearance of a voltage on the load side of the Disconnect Monitor Node during a power off condition could indicate illegal tampering and/or unauthorized use of electrical power. The communication device 55 transmits the data regarding the presence of a detected voltage to the utility 30. In some embodiments, the data can be transmitted through one or more communication networks 32 before being transmitted to the utility 30.

Further, in some embodiments, if a voltage is detected on the load side output 18, a disconnect service signal is triggered. In some embodiments, the voltage detecting circuit can also include a service switch 59 as an alternate embodiment of a monitoring device. When a sufficient voltage is detected on the load side output 18, the service switch 59 can communicate with the processor unit 54 to selectively connect and disconnect the service input 16 to and from the load side output 18.

In some embodiments, after the voltage detecting circuit detects a voltage on the load side output 18, the processor unit 54 sends a signal to one of the communication devices 55, 57 to transmit an alert signal to the utility 30 indicating that voltage is present on the load side output 18 of the meter assembly 10. The network address of the utility can be stored in the memory 92 of the processor unit 54. The memory might also contain the address of another node in the network to which it directly sends the alert signal, which other node is then responsible for relaying or routing the signal to the utility. In some embodiments, the message can be sent to a utility management system that can transmit a signal back to the communication device 55, so that the voltage detecting circuit receives a command whether to disconnect power from the service input 16 to the load side output 18. In other embodiments, the communication devices 55, 57 can be programmed to send a “power-off” signal to local devices and/or appliances 42 which might be deriving power from the load side output 18.

Other types of commands and data can also be received via one or both of the communication devices 55, 57 to control the operation of the Disconnect Monitor Node. For instance, the voltage threshold that is stored in memory and used to trigger the alert messages can be changed in response to a command to the processor 90 from the utility or another node on the network. Likewise, updates to the software programs stored in the memory can be sent from the utility or a utility management system via the communication devices.

The zero-crossing detection element 84 can detect the loss and restoration of service input power. When the voltage detecting circuit detects power loss, the zero-crossing detection element 84 signals the processor unit 54, which records the event in the memory storage 92 with a timestamp. The processor unit 54 signals the loss of power event to the rest of the voltage detecting circuit and then performs an orderly shutdown. Upon restoration of power, the voltage detecting circuit monitors the service voltage to determine stability, then signals the processor unit 54 of the restoration event, which records the event in the memory storage 92 with a timestamp.

During normal network operation, the voltage detecting circuit, or more specifically, one or both of the communication devices 55, 57, performs standard operations associated with powered devices 42 in the networks 32, 39. In some embodiments, standard operations of the voltage detecting circuit and communication devices 55, 57 can include, for example, acting as a network relay for other devices 42 in the networks 32, 39, acting as a proxy for downstream devices 42, acting to facilitate the distribution and synchronization of time and firmware upgrades, and/or acting as a gateway for devices 42 on different networks 32, 39, such as a ZigBee network serving device 42, or the like, or any combination thereof. In some embodiments, the primary RF transceiver 56 can provide the primary data communication, both receiving and transmitting signals, between the voltage detecting circuit, the utility 30, and various other communication networks 32. In some embodiments, the alternate transceiver 58 can provide the primary data signal communication gateway, both receiving and transmitting signals, between the voltage detecting circuit and devices 42 on one or more local networks 39. The number of signal pathways in the primary RF transceiver 56 connected between the front end processor 110 and the antenna 130 allow for communications over a range of signal frequencies. In some embodiments, the communication devices 55, 57 receive and transmit data from and to a LAN.

### DESCRIPTION OF OTHER POSSIBLE EMBODIMENTS

The Disconnect Monitor Node can be implemented in the form of several possible embodiments to achieve various functional capabilities. FIG. 3C illustrates the Disconnect Monitor Node with a Disconnect Switch to alert physical disconnection of the device or the power elements. FIG. 3D provides an illustration of the Disconnect Monitor Node with a battery-powered or capacitor-powered Last Gasp Device to provide network alert of power outage conditions in the smart-grid distribution network. FIG. 3E is a block diagram of the Disconnect Monitor Node with a Display Indicator. FIG. 3F illustrates the Disconnect Monitor Node with an FSU Interface for diagnostics, firmware upgrade, security authentication, etc. FIG. 3G shows the Disconnect Monitor Node with a Connector/Monitor/Controller to support a temporary connection and supply of power after network authentication to external user appliances/devices. FIG. 3H is a Disconnect Monitor node with interface to water and gas meters to enable network connectivity for those meters. Another embodiment is described in connection with FIG. 2, wherein the local network is a Home Area Network (HAN) connecting a variety of appliances and interfacing with the Disconnect Monitor Node to access the network gateway and the utility network server. These embodiments are further described below.

FIG. 3C illustrates one of the embodiments of the Disconnect Monitor Node 14 with a Disconnect Alert Device 70. This device is different from the service switch shown in FIG. 3B. The Disconnect Alert Device 70 senses physical disconnection of the Disconnect Monitor Node 14 from the electric meter assembly 10, and sends an alert signal to the Processor/Controller 40. The message is sent to the Utility Network 30 via the Communications Module/RF Transceiver 50. This arrangement provides an anti-tamper feature of the Disconnect Monitor Node 14.

FIG. 3D shows another embodiment of the Disconnect Monitor Node 14 with a battery-powered or capacitor-powered Last-Gasp device 71. This device can enable the system to function for a period of time on battery power, in case of electric power outage, and generate a last-gasp message for processing by the Controller 40, and transmission to the utility via the Communications Module 50. This device is also capable of sensing temporary loss of line-side power, voltage variations, etc. The Controller/Processor 40 is equipped to analyze the data, and report the information to the Utility 30 via the Communications Module 50. It can also communicate with the utility to inform it when power has been restored after an outage. In another embodiment of this invention, an alert message is created and sent to the utility 30 when voltage variations reach certain pre-determined, preset and configurable threshold values.

FIG. 3E depicts yet another embodiment of the Disconnect Monitor Node 14 with a Display Indicator 72. The Display Indicator 72 provides a visual display of key status parameters such as devices connected to the Disconnect Monitor Node 14, status of the power connection, voltage levels and status, and any persisting or recent alerts.

FIG. 3F is an embodiment of the Disconnect Monitor Node 14 with an FSU Interface 73 for diagnostics, firmware upgrade, security authentication, etc. The FSU Interface 73 can have a USB port for serial data link with an external PC; or a network connection via the Communications Module 50.

FIG. 3G is yet another embodiment of the Disconnect Monitor Node 14 with a Connector/Monitor/Controller Switch Interface 74 to support a temporary connection and supply of power after network authentication to external user appliances/devices. This interface 74 also acts as a settlement system, through an associated Settlement Processor 80. In one embodiment, the external device seeking temporary connection and supply of power can have a pre-issued authentication code and an IP address. This information is transferred to the Utility 30 via the Communications Module 50. The Utility can issue connection authorization and also establish billing protocol. The Connector switch 74 facilitates measurement of the power usage, establishment and termination of power connection per utility authorization.

FIG. 3H is an embodiment of the Disconnect Monitor node with Communication Interface 75 and 76 to water and gas meters to enable network connectivity for those meters. In this mode, the water and gas meters can continue to report back usage of the commodities to the Utility 30 utilizing the processor/controller 40 and Communication Module 50.

Another embodiment is described with reference to FIG. 2, wherein the local network is a Home Area Network (HAN) connecting a variety of appliances and interfacing with the Disconnect Monitor Node to access the network gateway and the utility network server. The Local Network 39 can be an Home-Area Network (HAN), also referred to as an in-prem network. Several appliances 42 such as a refrigerator, a thermostat, heating/cooling units, swimming pool control, home surveillance system, and others, can be connected to the Local Network 39. The local network 39 uses a communications protocol which can be one of IPv4, IPv6, Zigbee, or other proprietary protocols. The Local Network interfaces with the Disconnect Monitor Node 14, and uses it as a gateway for communicating with the Utility 30. In one embodiment, the Local Network can use the Processor/Controller of the Disconnect Monitor Node 14 to conduct such functions as processing, storing, evaluating, scheduling, and controlling its network elements and data.

The embodiments described above and illustrated in the figures are presented by way of example only and are not intended as a limitation upon the concepts and principles of the present invention. Various features and advantages of the invention are set forth in the following claims.

What is claimed is:

1. A device for use in a utility network, comprising:
a premises voltage detector capable of detecting voltage on an electrical power distribution circuit of a premises;
memory for storing computer readable instructions;
a processing unit communicatively connected to the premises voltage detector and memory; and
a communications module communicatively connected to the processing unit and capable of communicating with the utility network,
wherein the processing unit sends an alert message to another node in the utility network in response to detection of a voltage in the electrical power distribution circuit of the premises that is above a preset voltage threshold.

2. The device of claim 1, wherein the alert message sent to the other node in the utility network is directed to a utility management system in communication with the utility network, according to a predetermined network address stored in the memory of the device.

3. The device of claim 1, wherein the preset voltage threshold stored in memory of the device can be changed by the processing unit in response to receiving a change preset voltage detection threshold instruction received by the communications module from another node in the utility network.

4. The device of claim 1, wherein the alert message is sent in response to detection of voltage in the electrical power distribution circuit of the premises after a power off condition in the electrical power distribution circuit of the premises.

5. The device of claim 1, wherein the communications module relays messages between nodes in the utility network, and wherein at least one of the nodes in the utility network is a utility node coupled to an electric utility meter for reporting the electrical usage of a second premises associated with the electric utility meter.

6. The device of claim 1, further comprising:
a secondary meter interface for communicating with a meter for at least one of gas or water service from a utility.

7. The device of claim 1, further comprising:
an electric utility meter base for mounting to an electric utility meter socket, wherein the processing unit, memory, and communications module are securely mounted to the electric utility meter base.

8. An electrical power monitoring device for use in monitoring electrical power in a facility, comprising:
a processing unit for processing computer readable instructions;
memory coupled to the processing unit for storing computer readable instructions,
a communications module coupled to the memory and processing unit, the communications module being capable of communicating with a utility network;
a facility voltage detector coupled to the processing unit and capable of informing the processing unit of the status of voltage on the facility's electric power distribution circuit; and
an electrical power monitoring device base for securely mounting the processing unit, facility voltage detector, memory and communications module, wherein the electrical power monitoring device base is formed to connect to a socket of an electric utility meter service box such that the facility voltage detector is electrically connected to the facility's electric power distribution circuit,
wherein the processing unit sends a power detection alert to another node in the utility network in response to detecting an increase in voltage on the facility's electric power distribution circuit.

9. The power monitoring device of claim 8, wherein the base has the shape of an electric utility meter service box blank.

10. The power monitoring device of claim 8, wherein the power detection alert is only sent if the detected voltage is above a preset voltage value.

11. The power monitoring device of claim 8, wherein the processing unit sends a power loss alert to another node in the utility network in response to detecting a decrease in voltage on the facility's electric power distribution circuit.

12. The power monitoring device of claim 8, wherein the power detection alert is only sent if the voltage of the facility was below a preset voltage level prior to the detected increase.

13. The power monitoring device of claim 8, wherein the communications module relays messages between nodes in the utility network, and wherein at least one of the nodes in the utility network is a utility node coupled to an electric utility meter for reporting the electrical usage of a facility associated with the electric utility meter.

14. The device of claim 8, further comprising:
a secondary meter interface for communicating with a meter for at least one of gas or water service from a utility.

15. A facility electric power monitoring device, comprising:
a communications module capable of communicating in a utility network, the communications module including:
memory for storing computer readable instructions, and
a processing unit coupled to the memory, wherein the processing unit is capable of implementing computer readable instructions; and
a voltage detector capable of detecting voltage on a facility's electric power distribution circuit, the voltage detector being communicatively coupled to the processing unit,
wherein the communications module determines whether a resumed power or power loss condition has occurred and sends a message to another node in the utility network in response to a determination of either the resumed power or power loss condition.

16. The device of claim 15, further comprising:
a power monitoring device base for securely mounting the communications module and voltage detector, the power monitoring device base being formed to connect to a socket of an electrical utility service panel.

17. The device of claim 16, wherein the power monitoring device base has the shape of an electric utility meter service box blank.

18. The device of claim 16, further comprising:
a facility voltage condition display securely attached to the power monitoring device base, wherein the facility voltage condition display provides a visual indication of a voltage on the facility's electric power distribution circuit.

19. The device of claim 15, wherein the communications module relays messages between nodes in the utility network, and wherein at least one of the nodes in the utility network is a utility node coupled to an electric utility meter for reporting the electrical usage of a premises associated with the electric utility meter.

20. The device of claim 15, further comprising:
a secondary meter interface, the secondary meter interface being communicatively coupled to the communications module, and wherein the secondary meter interface is operative to communicate with at least one of a gas meter or water meter.
